(19) United States
(12) Patent Application Publication
(10) Pub. No.: US 2007/0281854 A1
(43) Pub. Date: Dec. 6, 2007

(54) Metal Oxide/Hydroxide Materials

(75) Inventors: Peter James Harbour, Kilsyth (AU); Patrick Gordon Hartley, Malvern (AU)

Correspondence Address: BACON & THOMAS, PLLC, 625 SLATERS LANE, FOURTH FLOOR, ALEXANDRIA, VA, 22314, US

(73) Assignee: Commonwealth Scientific and Industrial Research Organisation, Campbell, Australian Capital Territory (AU)

(21) Appl. No.: 10/578,620

(22) PCT Filed: Nov. 5, 2004
(86) PCT No.: PCT/AU04/01523

§ 371 Date: Jan. 26, 2007

(30) Foreign Application Priority Data
Nov. 6, 2003 (AU) 2003906123

(51) Int. Cl. B01J 23/52; B01J 21/06; B01J 23/06; B01J 23/08; B01J 23/14; B01J 23/18; B01J 23/20; B01J 23/22; B01J 23/745; B01J 37/03; B01J 23/755; B01J 23/75; B01J 23/72; B01J 23/26; B01J 23/28; B01J 23/30; B01J 23/34; B01J 23/36; B01J 23/42

(52) U.S. Cl. 502/156; 502/175; 502/200; 502/201; 502/217; 502/224; 502/240; 502/300

(57) ABSTRACT

Metal oxide/hydroxide materials and composite metal oxide/hydroxide materials comprising a surface modified to facilitate co-continuity to an external environment, the metal oxide/hydroxide or composite material having a high mesoporous area. Processes for preparing and using these materials.

### FIELD OF THE INVENTION

The present invention relates generally to metal oxide/hydroxide material having co-continuous architecture. More particularly, the present invention is directed to a metal oxide/hydroxide or a composite metal oxide/hydroxide material having a surface which has been modified to have co-continuous architecture. The co-continuous architecture of the metal oxide/hydroxide or composite material permits or otherwise facilitates accessibility of the surface of the material to an external environment. The accessible, i.e. co-continuous, nature of the surface of the materials of the invention allows the materials to be used in applications where high surface area metal oxide/hydroxide materials are required. The processes for generating such high surface areas in the materials of the present invention also generally provides useful mesoporosity characteristics which make them useful in various applications where mesoporous metal oxide/hydroxide materials are required. The metal oxide/hydroxide materials of the present invention may be used as catalysts, for example in the removal of SO₂, NO and HCl, in energy generation and storage, for example in the production of supercapacitors or in the preparation of electrodes and fuel cells, in water treatment, for example in water filtration to remove organic chemical species, bacteria, viruses, heavy metals and other contaminants, in separation processes, such as the removal of metal ions from solutions, or as templates for metal oxide nanoparticle preparation. The present invention further provides processes for generating these metal oxide/hydroxide and composite metal oxide/hydroxide materials, and their use in applications such as those referred to above.

### BACKGROUND OF THE INVENTION

Reference to any prior art in the specification is not, and should not be taken as, an acknowledgment or any form of suggestion that this prior art forms part of the common general knowledge in Australia or in any other country.

Bibliographic details of the publications referred to in this specification are collected at the end of the description.

Mesoporous metal oxide/hydroxide and composite metal oxide/hydroxide materials, such as activated carbon/metal oxide composites, activated carbon/metal hydroxide and mesoporous silica/metal oxide materials, have a number of uses ranging from water treatment and separation processes to catalysts for chemical reactions or toxic gas removal, and through to energy generation and storage applications, such as in the production of supercapacitors and the preparation of electrodes, such as those used in fuel cells.

Various methods have been described in the prior art for making and using these materials, however these processes are limited in relation to the surface area per weight of material which can be achieved.

The production of composite activated carbon/iron oxide materials having magnetic properties for use in the treatment of water has been described by Oliviera, Luiz C. A.; Rios, Rachel V. R. A.; Fabris, Jose D.; Garg, V.; Sapag, Karam; Lago, Rochel M. Carbon 40:2177-2183, 2002. This process involved the suspension of activated carbon in a solution of FeCl₃ and FeSO₄ at elevated temperature followed by treatment with a large excess (>4 to 5 times the stoichiometric ratio need to give a neutral solution) of sodium hydroxide to precipitate the magnetic ion oxides, magnetite and maghemite. These oxides were then obtained and dried in an oven to produce composite materials having surface areas, as determined by BET, of 658 m²/g. When the iron oxide material was prepared in the absence of the activated carbon the surface area obtained was only 66 m²/g.

Perez-Maqueda, Luis A.; Criado, Jose Manuel; Real, Concepcion; Balek, Vladimir; Subrt, Jan. Journal of the European Ceramic Society, 22:2277-2281 (2002) describe the preparation of porous hematite by subjecting goethite to thermal decomposition using constant rate thermal analysis equipment. The porous hematite product had a low surface area, with 85 m²/g being the maximum achieved.

Schwickardi, Manfred; Jaohann, Thorsten; Schmidt, Wolfgang; Schuth, Ferdi, Chem. Mater. 14:3913-3919 (2002) describe the preparation of high surface area oxides using activated carbon. These materials were prepared by combining activated carbon with metal nitrates and subjecting the mixture to calcination at high temperature for a short period of time. When using Fe(NO₃)₃ the calcination was performed at 450° C. for 1 hour. The best surface area which could be achieved for this material via this route was 123 m²/g.

Tseng, Hui-Hsin; Wey, Ming-Yen, Liang, Yu-Shen; Chen, Ke-Hao, Carbon 41:1079-1085 (2003) describe the catalytic removal of SO₂, NO and HCl from incineration flue gas using activated carbon-supported metal oxides. These materials were prepared by impregnating pre-treated activated carbon material with aqueous solutions of nitrite salts followed by stirring and heating to remove most of the liquid. The impregnated activated carbon was then dried followed by calcination at high temperature (500° C.) for 4 hours. For Fe₂O₃ the best surface area achieved for the composite material was 897 m²/g. The material also had a low mesoporous volume of 0.0503 cm³/g.

Ching-Chen Hung (U.S. Pat. Nos. 5,948,475 and 5,876,687) describes processes for preparing various metal oxide, metal and composite materials which involve the exposure of graphite oxide to a metal chloride to form an intermediate carbonaceous product comprising elements of metal, oxygen and chlorine. This product is then treated to remove the chlorine and/or the carbon. This latter treatment involves heating to temperatures of 250° C. and above. It is clear from the data presented in the specification that the surface areas achieved utilising these processes were very low.

Oh et al. in WO01/89991 describe the preparation of mesoporous carbon material, carbon/metal oxide composite materials and electrochemical capacitors prepared from them. No surface area data is provided for the metal oxide containing materials.

In the present invention new metal oxide/hydroxide and metal oxide/hydroxide composite materials have been identified which have high surface areas and/or high mesoporous areas, making them particularly useful in a number of important applications. Methods of generating these materials have also been identified which may be performed using inexpensive materials and relatively low temperatures compared to the prior art processes. These processes may be used to produce metal oxides/hydroxides and metal oxide/hydroxide composite materials having more surface area continuous with the external environment than prior art materials. Such a state is referred to herein as “co-continuous”.

### SUMMARY OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The present invention relates generally to the generation of metal oxide hydroxide and composite metal oxide hydroxide material with co-continuous architecture and other properties. In particular, the present invention provides metal oxides hydroxides and composite metal oxide hydroxide materials having co-continuous architecture, where “co-continuous” means that the accessibility of the surface of the material to an external environment is facilitated. This co-continuity can generally be achieved through a multiplicity of pores or porous-like structures. The pores or porous-like structures may exist singly or each porous region may comprise multiple pores or porous-like structures, resulting in a potentially high extensive surface which is co-continuous with the external environment.

The accessibility of the surface to the external environment (i.e. co-continuity) facilitates contact with the materials during chemical and electrochemical processes and in separation and adsorption applications.

Accordingly, the present invention provides a metal oxide/hydroxide or composite metal oxide/hydroxide material comprising a surface modified to facilitate co-continuity to an external environment.

In a preferred method according to the invention the metal oxide/hydroxide material is prepared by treating a metal salt with a base to precipitate metal oxide/hydroxide followed by solvent removal under conditions that generate material having a surface facilitating co-continuity to an external environment. The conditions for solvent removal may also convert any metal hydroxide to metal oxide. Following solvent removal the solid residue is treated to remove any residual salt.

Accordingly the present invention provides a process for generating a metal oxide/hydroxide material with a surface modified to facilitate co-continuity to an external environment comprising treating a metal salt with base in an aqueous medium for a time and under conditions sufficient to precipitate metal oxide/hydroxide in said aqueous medium, removing water from the aqueous medium by evaporation to provide a solid residue, and removing salt from the solid residue to thereby generate said metal oxide/hydroxide material with surface modified to facilitate co-continuity to an external environment.

The term “metal oxide/hydroxide” is to be understood to refer to a single metal oxide, a mixture of metal oxides, a single metal hydroxide, a mixture of metal hydroxides, mixture of metal oxides and hydroxides of the same or different metal, as well as oxyhydroxides and mixtures thereof. Whether the met atrial is in the form of an oxide, hydroxide, oxyhydroxide or mixture will necessarily depend on the nature of the metal and the conditions to which the metal salt and hydroxide are subjected during preparation, or following preparation. Reaction of the metal salt with the base in an aqueous medium will generally form the hydroxide of the metal. However, some metal hydroxides readily convert to the corresponding oxides in aqueous medium, particularly if the aqueous medium is exposed to air. In some cases, there may be partial conversion to the oxide, thereby providing a mixture of hydroxide and oxide. Where two metal salts are contacted with base to form hydroxides of both metals, one hydroxide may be readily converted to the oxide, while the other may remain as the hydroxide. Further, the hydroxides of some metals, such as Fe and Ti, readily convert to their corresponding oxides in the aqueous medium during the evaporation step. Other hydroxides, such as NiOH, require harsh conditions to enable conversion to the corresponding hydroxide. The terms “metal oxide/hydroxide composite”, “metal oxide/hydroxide composite material” and “composite metal oxide/hydroxide material” are to be understood to refer to such a metal oxide/hydroxide material in combination with a substrate material. This substrate material may be a substrate having a surface modified to facilitate co-continuity to an external environment. Examples of such substrate materials include activated carbon including activated cloth carbon, mesoporous silica, metals, structured or unstructured synthetic polymer materials, natural biopolymer materials, polymer/inorganic hybrid materials, other two phase systems, such as emulsions and gels, self assembled structures, such as surfactant lyotropic mesophases, weaved materials, such as porous fabrics and fibres, carbon nanotubes and other high aspect ratio materials, synthetic polymer foam and inorganic foams, metal foams and biologically deposited organic and inorganic structures, such as diatom skeletal materials.

Accordingly the present invention provides a composite metal oxide/hydroxide material comprising a substrate with a surface modified to facilitate co-continuity to an external environment and a metal oxide/hydroxide material attached to, bound within or otherwise associated with said substrate such that the composite material maintains co-continuity to an external environment.

In a preferred process according to the invention such composite metal oxide/hydroxide material is prepared by precipitating metal oxide/hydroxide material in the presence of a substrate with a surface modified to facilitate co-continuity to an external environment. Such a substrate may be a metal oxide hydroxide or composite metal oxide hydroxide material prepared according to the invention, or may be a mesoporous substrate, such as activated carbon or mesoporous silica or the like as described above.

Accordingly the present invention provides a process for generating a composite metal oxide/hydroxide material with a surface modified to facilitate co-continuity to an external environment comprising treating a metal salt with a base in an aqueous medium in the presence of a substrate with a surface modified to facilitate co-continuity to an external environment for a time and under conditions sufficient to precipitate metal oxide/hydroxide, removing water from the aqueous medium by evaporation to provide a solid residue of metal oxide hydroxide attached to, bound within or otherwise associated with said substrate, and removing salt from the solid residue to thereby generate said composite metal oxide/hydroxide material with surface modified to facility co-continuity to an external environment. As for the preparation of the metal oxide/hydroxide material the conditions for solvent removal may also convert any metal hydroxide to metal oxide.

### DETAILED DESCRIPTION OF THE PREFERRED EMBODIMENTS

The present invention is predicated in part on the generation of metal oxide/hydroxide and composite metal oxide/hydroxide materials with co-continuous architecture and other properties. These materials have extensive surface regions freely accessible, i.e. co-continuous, to the external environment.

Reference to the “external environment” in this context includes a surrounding solvent, solution or other liquid, gel, vacuum or gaseous environment comprising, for example, entities capable of reacting or interacting or binding with the surface of the material, or accepting or donating electrons from and to the surface of the material.

A solvent is any liquid phase in which reactants are dissolved, suspended or dispersed in the liquid medium. Solvents include, but are not limited to, polar or non-polar, protic or aprotic solvents such as hydrocarbons (e.g. petroleum ethers, benzene, toluene, hexane, cyclohexane), chlorinated solvents (e.g. dichloromethane, carbon tetrachloride) and other halogenated solvents including fluorinated or brominated solvents, dialkyl ethers (e.g. diethylether, tetrahydrofuran), alcohols (e.g. methanol, ethanol, propanol and butanol), acetonitrile, ethylacetate and aqueous media, including buffer solutions or water alone. The solvent may also be a solvent mixture.

The external environment may also include other liquid environments, such as raw water, for example, from a river, reservoir or the like, industrial waste water, hospital waste water, domestic waste water or industrial process water. The liquid may also be other liquid materials that have been utilised in industrial processes. The liquid material (or gel) could also be an electrolyte solution used in an electrolysis cell, battery, capacitor or the like.

The external environment may also be a gaseous environment, such as an inert gas, for example, a nitrogen atmosphere or air, exhaust gas, combustion engine or industrial process gas, vapours, or the like, biologically generated gases from industrial fermentation processes or sewage or exhaled/emitted from plants and animals, such as CO₂, methane etc.

The metal oxides hydroxides and metal oxide hydroxide composite materials according to the present invention may be in the form of spheres, rods, sheets, blocks, fibres, discs, capsules, networks, weaves or biologically deposited complex structures, such as diatom skeletal materials. The shape of the material may be dictated by the apparatus used to manufacture the material, or the generated materials may be subjected to treatments which alter or refine shape following generation. The shape of the material may be dictated by the shape of the substrate material used in the case of the composite metal oxide materials. Particularly preferred shapes are those that enhance the activity of the material for its intended purpose.

The metal salts which are hydrolysed with base to produce the metal oxides/hydroxides may be any water soluble metal salt that is capable of being converted to an insoluble oxide/hydroxide by treatment with base. Depending on the nature of the oxide hydroxide material desired, mixtures of salts may be used, including mixtures of salts of different metals. This may produce mixed metal oxide/hydroxide materials. Examples of suitable metal salts include the halides (e.g. chlorides, fluorides, bromides and iodides), acetyl acetonates, sulphides, sulphates, nitrates, nitrides, cyamides, carbides, silanes, alkoxysilanes, and acetates of transition metal (d-block) elements such as titanium, zirconium, vanadium, niobium, tantalum, chromium, molybdenum, manganese, iron, ruthenium, cobalt, rhodium, iridium, nickel, silver, copper, zinc, mercury, cadmium, tungsten, lanthanum and gold, of transition metals (f-block) in the lanthanoid series such as cerium, praseodymium and neodymium, and the actinoid series such as uranium, thorium, neptunium, plutonium and americium, as well as of s-block metal elements such as beryllium, calcium, strontium, barium, radium, cesium, magnesium, and of p-block metal elements such as lead, aluminium, arsenic, tin, gallium, bismuth, antimony, germanium, indium and tellurium. Other suitable metal salts include those comprising halogen oxoanions (such as bromate and iodate), metal and transition metal oxoanions (such as permanganate, chromate and arsenate) and organic oxoanions, such alkoxides and carboxylates (e.g. ethoxides, acetates and palmitates). In some cases it may be necessary or beneficial to pretreat a salt to place it in a suitable or optional oxidation state for oxide/hydroxide formation. For example Manganese (II) chloride may benefit from oxidation with an oxidising agent such as permanganate or peroxide to form Manganese (IV) species prior to or during base treatment. Similarly Ti(III) chloride can benefit from oxidation to Ti(IV) before it can form its oxide/hydroxide. Particularly preferred salts for producing iron oxide materials are those of Fe³⁺, such as Fe(III) nitrate, chloride, chlorate, sulphate, perchlorate, nitrite, silicate, borate or phosphate. Preferred salts for producing titanium oxide materials include those of Ti(III) such as TiCl₃, and those of Ti(IV) such as TiCl₄, and preferred salts for producing Ni oxide and hydroxide materials include those of Ni(II) such as NiCl₂, NiSO₄ and Ni(NO₃)₂.

The use of mixed or doped materials is also contemplated, where the mixing/doping of additional metals, metal salts, complexes or other chemical species (including biological species e.g. proteins, DNA) confers desirable properties such as fluorescence, electroluminescence, magnetism, semi-conductivity or biological activity on the final material.

Where it is desired to produce a composite metal oxide/hydroxide material the precipitation of the metal oxide/hydroxide may be conducted in the presence of a substrate with a surface modified to facilitate co-continuity to an external environment. Examples of such materials include activated carbon, mesoporous silica or the like as described above, or metal oxide/hydroxide or composite metal oxide/hydroxide materials prepared according to the invention. In order to prepare a suitable composite metal oxide/hydroxide material the metal salt and the substrate may be combined in a suitable ratio in an aqueous medium in the presence of a base. The ratio selected will depend on the nature of the substrate and the amount of metal oxide to be introduced into the composite material. It will also depend on the atomic weight of the metal salt. The metal salt and the substrate will generally be combined in a weight ratio of from 1:100 and 100:1, more preferably from 50:1 to 1:50, more preferably from 10:1 to 1:10. For Fe(III) nitrate a ratio of from 5:1 to 1:1 is preferably advantageous. For the preparation of nickel electrodes a weight ratio of from about 1:1 to 1:3 carbon to metal is particularly suitable. For titania, lower ratios may be preferable, for example in the range of 1:10 or 1:100 carbon to metal. The small amount of carbon can darken the titania to an extent that the absorption of visible light is increased, which may increase the photocatalytic activity of titania in visible light. A person skilled in the art could determine the optimal ratio for a particular application.

The metal salt is converted to the metal oxide/hydroxide by increasing the pH of the aqueous solution. This may be done by introducing a suitable base into the aqueous medium. Preferably the base is an inorganic base, such as a strong inorganic base. Examples of suitable strong inorganic base include sodium hydroxide, potassium hydroxide and ammonium hydroxide. While the pH to which the aqueous medium is adjusted will depend on the particular metal hydroxide/oxide to be formed, the pH is generally adjusted to within a range of 7 to 11, more preferably 7.5 to 8.5.

The conversion of the metal salt to the metal oxide/hydroxide generally takes place very quickly at room temperature, although it may be possible to increase the rate by applying heat and by agitating or stirring the aqueous medium. In some cases heat and/or exposure to air is necessary to convert the hydroxide to the oxide. In other cases, harsh conditions are required if it is desired to convert the hydroxide to the oxide. Progress of the conversion of the metal salt can be monitored by testing the medium for the presence of metal salt, or by monitoring the formation of the precipitate. The precipitate will generally form as a gel in the aqueous solution. The optimum final pH will be dependant on the metal salts and substrates used. The pH may be chosen to maximise the amount of hydroxide precipitate formed i.e. that conditions are such that the pH is within the precipitation edge for that metal. Also it may be that the pH is required to be somewhere near the iso-electric point (iep) of the final solid surface, either hydroxide, oxide, oxyhydroxide or combinations thereof to prevent dispersion of the solids formed by electrostatic surface forces. In some cases, where these two pH values do not correlate it may be necessary to compromise between the two pH values. In cases where the pH is too low or too high the reaction may favour production of non-mesoporous particles and/or, in some cases, nanoparticles. For example for metals such as Ti and Fe the amount of base is generally chosen such that the final pH of the mixture reaches and stabilises at pH 7.5-8.5. Final pH stability is assumed when the pH no longer changes for a period of about 5 minutes after an addition. Concentrated base (e.g. 6M) can be used in order to maximise the speed of precipitation. Base is preferably added to a stirred mixture (e.g. using a magnetic stirrer) dropwise from a pipette at room temperature until the pH is reached, as determined from a pH probe immersed in the stirring mixture. Typically the addition is completed within approximately 15 minutes of initial addition, although the exact time and conditions will depend on the particular metal salts and substrates used.

In an embodiment the invention provides a process for generating a metal oxide material with a surface modified to facilitate continuity to an external environment comprising treating a metal salt with base in an aqueous medium for a time and under conditions sufficient to precipitate metal hydroxide in said aqueous medium, removing water from the aqueous medium by evaporation under conditions that convert metal hydroxide to metal oxides to provide a solid residue, and removing salt from the solid residue to thereby generate said metal oxide material with surface modified to facilitate co-continuity to an external environment.

In another embodiment the invention provides a process for generating a composite metal oxide material with a surface modified to facilitate co-continuity to an external environment comprising treating a metal salt with base in an aqueous medium in the presence of a substrate with a surface modified to facilitate continuity to an external environment for a time and under conditions sufficient to precipitate metal hydroxide, removing water from the aqueous medium by evaporation under conditions that convert metal hydroxide to metal oxide to provide a solid residue of metal oxide attached to, bound within or otherwise associated with said substrate, and removing salt from the solid residue to thereby generate said composite metal oxide material with surface modified to facilitate co-continuity to an external environment.

In yet another embodiment the invention provides a process for generating a metal hydroxide material with a surface modified to facilitate co-continuity to an external environment comprising treating a metal salt with a base in an aqueous medium for a time and under conditions sufficient to precipitate metal hydroxide in said aqueous medium, removing water from the aqueous medium by evaporation under conditions that do not convert the metal hydroxide to metal oxide to provide a solid residue, and removing salt from the solid residue to thereby generate said metal hydroxide material with surface modified to facilitate co-continuity to an external environment.

A further embodiment of the invention provides a process for generating a composite metal hydroxide material with a surface modified to facilitate co-continuity to an external environment comprising treating a metal salt with base in an aqueous medium in the presence of a substrate with a surface modified to facilitate continuity to an external environment for a time and under conditions sufficient to precipitate metal hydroxide, removing water from the aqueous medium by evaporation under conditions that do not convert the metal hydroxide to metal oxide to provide a solid residue of metal hydroxide attached to, bound within or otherwise associated with said substrate, and removing salt from the solid residue to thereby generate said composite metal hydroxide material with surface modified to facilitate co-continuity to an external environment.

After formation of the precipitate/gel of metal hydroxide/oxide in the aqueous medium, the water in the aqueous medium is removed. While the usual method for recovering a precipitated metal oxide/hydroxide from an aqueous solution would involve a filtration step followed by oven drying, it has been surprisingly found that advantageous mesoporosity in the metal oxide/hydroxide or metal oxide/hydroxide composite material can be obtained if the water is removed primarily or totally via evaporation. While not wishing to be limited by theory, it is believed that the presence of the salts in the aqueous medium and their concentration through the evaporation process and consequential rise in ionic strength help to retain the network structure in the metal oxide hydroxide particles upon which further dehydration react to form an interconnected mesoporous material. It is believed that the maintenance of the original gel network structure via control of the surface chemistry (pH, ionic strength) causes the mesoporosity in the metal oxide/hydroxide material, thereby contributing to the co-continuity of the material to an external environment. Evaporation of the water from the aqueous medium can be enhanced by the application of heat. Temperatures of about 100° C. and slightly above, for example from 100° C. to 110° C., preferably about 105° C., are sufficient for this purpose. If oxides are desired this heating step can be essential in the case of metal hydroxides which require heat in order to form corresponding oxides. It is possible to modify the properties of the resultant mesoporous material by addition of salt to further increase the ionic strength or by removing some of the aqueous medium prior to evaporation. Care needs to be taken in such circumstances as too much salt or too little can be detrimental to the formation of the desired mesoporosity. Accordingly while doubling the concentration of salt might be acceptable in some cases, a tenfold increase in salt concentration would be expected to be detrimental in most cases.

The conditions during the removal of the water from the aqueous medium should be selected such that the dried residue includes metal oxide/hydroxide or metal oxide/hydroxide composite material that, following the removal of residual salt, has a high degree of co-continuity to an external environment. An important measure of co-continuity to an external environment is surface area. In the case of metal oxide/hydroxide materials, including mixed metal oxide/hydroxide materials, the material may have a surface area as measured by BET of greater than 100 m²/g, preferably greater than 200 m²/g, more preferably greater than 250 m²/g. In the case of composite materials involving substrates which already have surfaces modified to facilitate co-continuity to external environments, the final surface area of the material will be in some way dependent upon the surface area of the substrate utilised. However, the surface area of the composite material following metal oxide/hydroxide deposition may be greater than 700 m²/g, preferably greater than 900 m²/g, more preferably greater than 1000 m²/g.

The metal oxide/hydroxide or mixed metal oxide/hydroxide materials of the present invention are preferably mesoporous. Mesoporous materials generally have an average pore size of from about 2 to 50 nanometers, although for most applications a pore size of from 2 to 20 or 2 to 10 nanometers is more desirable.

The metal oxide/hydroxide and composite metal oxide/hydroxide materials of the present invention may also have a high mesoporous area, as measured by BJH. In the case of metal oxide materials, the mesoporous area may be greater than 100 m²/g, preferably greater than 150 m²/g and more preferably greater than 200 m²/g. For the metal oxide composite materials the mesoporous area as measured by BJH may be greater than 500 m²/g, preferably greater than 800 m²/g and most preferably greater than 1000 m²/g.

After evaporation of the water and conversion, if necessary, of the hydroxide to the oxide material, it is necessary to remove any residual salt from the metal oxide or composite metal oxide material. This salt is formed during the hydrolysis step when the metal salt is converted to the oxide/hydroxide material. This salt can generally be removed by simple washing of the metal oxide/hydroxide or composite metal oxide/hydroxide material in water. This washing step may be performed by agitating the metal oxide material in a vessel, allowing it to settle and pouring off the water. This washing step may be repeated, after which the material may be dried, for example in a vacuum oven at a suitable temperature, such as 50 to 60° C.

For some applications the metal should be presented in its metallic form. For example, when preparing electrodes for fuel cells any platinum oxide would need to be reduced to platinum metal. Similarly for odour absorbing properties it would be desirable for copper oxide to be reduced to copper metal and for antibacterial properties silver oxide should desirably be converted to silver metal. This may be achieved by subjecting the mesoporous metal oxide/hydroxide or composite metal oxide/hydroxide material to reducing conditions such that the oxide/hydroxide is reduced to the corresponding metal. The conditions used will depend on the oxide/hydroxide to be reduced. Preferably the conditions are such that the mesoporosity of the oxide/hydroxide or composite material is substantially maintained. For example, in the case of CuO, hot mesoporous copper oxide may be reduced to copper metal under a reducing environment such as under a hydrogen atmosphere or methane atmosphere in the absence of oxygen.

The metal oxide/hydroxide and composite metal oxide/hydroxide materials of the present invention may be used directly as prepared, or may be incorporated into devices or equipment for achieving their intended function. For example, when the materials are to be used as catalysts in the removal of toxic components such as SO₂, NO and HCl, particles of the materials may be packed into a bed, possible fluidised, incorporated into a membrane or fibre or filter, possibly in cartridge form, or attached to or supported by another material, e.g. a polymer or inorganic or metallic material. Where the materials are to be used as catalysts for chemical reactions, particles of the material can be simply introduced into the reaction medium, generally a solvent, whereby the material can act as a catalyst for the reaction. Similarly, gas phase reactions may be catalysed by passing the gaseous reactants through a tube packed with appropriate metal oxide/hydroxide or composite metal oxide/hydroxide material. The high mesoporosity of the materials according to the present invention allow them to be incorporated into the plates of supercapacitors. For these applications the materials should be conducting. Since capacitance varies directly with electrode area, increasing this area by incorporation of a material according to the present invention will contribute to the capacitance of the capacitor. When used in water treatment processes, beads or particles of the material can be dispersed in the water to facilitate removal of organics, bacteria, viruses, heavy metals and other contaminants. Alternatively the water or the liquid can be passed through a column packed with the metal oxide/hydroxide material. For water treatment processes it is also possible to produce magnetic metal oxide/hydroxide and composite metal oxide/hydroxide materials and utilise the magnetic nature of these materials to assist in their recovery following dispersion in the water to be treated. In the case of domestic type situations, the mesoporous materials of the present invention, such as Fe composite material, may be introduced into a cartridge in the tap or tap line.

In the case of composite materials, they will generally have improved properties relative to the substrate material employed. Such advantages may include higher density, improved wettability, improved charge and improved surface chemistry. They may also have improved pH stability relative to commercially available materials used for the same or similar purpose. A person skilled in the art would understand that different metals are associated with different properties and would be able to select a particular metal for a particular application. For example Cu materials are suitable for absorbing odours, NiOH materials are particularly useful in supercapacitors, platinum containing materials are useful as electrodes for fuel cells, and silver containing materials are suitable bacteriocides. It has also been found by testing some materials of the present invention that some materials are particularly useful for particular applications. For example mesoporous iron oxide has been found to be particularly suitable for the removal of arsenic from water. Similarly, composite ion/activated carbon material has been found to be particularly useful for the removal of humics from water.

Those skilled in the various arts would be able to make and utilise the materials and processes of the present invention to readily prepare materials suitable for the desired end application.

The present invention is further described with reference to the following non-limiting examples.

### EXAMPLE 1

### Preparation of Mesoporous Iron Oxide

5 g of Fe(NO₃)₃.9H₂O was dissolved in 60 ml of Milli-Q water in a 100 ml beaker. The pH of the resultant solution was increased rapidly from approximately 1.4 to 8.2 using 6 M NaOH with rigorous stirring. Following this step the concentration of soluble NaNO₃ was measured to be approximately 0.6M The beaker was then placed in a hot oven uncovered at 105° C. overnight (14 hours). During this state the insoluble ferric hydroxide gel network dehydrated to form ferrihydrite and goethite, with consequential reduction in pH. The following morning the beaker was removed from the oven and the dry salty disk of very dark brown/purple material that had formed was rinsed immediately with Milli-Q water. Rinsing was performed by filling the beaker with agitation, settling the solid material briefly and pouring off the supernatant. This involved the loss of a small portion of dark coloured fines which were still suspended. The rinsing process was repeated 9 times. The material was then place in a vacuum oven at 60° C. and vacuum (625 mm Hg) and dried, prior to BET, and SEM measurement. The average particle size of the mesoporous iron oxide was >1 micron.

### EXAMPLE 2

### Preparation of Iron Oxide/Activated Carbon Material

5 g Fe(NO₃)₃9H₂O was dissolved in 60 ml Milli-Q water in a 100 ml beaker. 5 g of BP2000 carbon was dispersed in this solution with gentle stirring. The pH of the resultant solution was increased rapidly from approximately 1.4 to 8.2 using 6 M NaOH with rigorous stirring (magnetic bead on magnetic stirrer). The beaker was placed in the preheated oven at 105° C. and left overnight leaving a dried black disk in the beaker. The dried black disk was rinsed/washed with Milli-Q water. Rinsing/washing was performed by filling the beaker with water, followed by agitation, settling the solid material briefly and pouring off the supernatant. This process resulted in the loss of a small amount of fines. The rinsing process was repeated 9 times. The material was then place in a vacuum oven at 60° C. and vacuum (625 mm Hg) and dried, prior to BET measurement.

Notes.

5 g of Fe(NO₃)3.9H₂O forms approximately 1 gram of Fe₂O₃, therefore the ratio of iron oxide to carbon for this material is approximately 1:5.

### EXAMPLE 3

### BET and BJH Measurements

BET surface area measurements were determined by multi-point gas adsorption using a Micromeritics ASAP 2400 surface area analyser. Nitrogen was used as the adsorbate at −196° C. Prior to analysis, samples were vacuum degassed, at 100° C., to an ultimate vacuum of <10 Pa.

BET surface area is derived from the gas adsorption/desorption isotherm which is a measure of the molar quantity (or standard Volume) of gas adsorbed (or desorbed), at a constant temperature, as a function of pressure. The BET equation, in its linear form, can be written as:

$$\frac{P}{Va ( Po - P )} = \frac{1}{VmC} + \frac{C - 1}{VmC} \cdot \frac{P}{Po}$$

Where

P=Pressure

Pₒ=Saturation pressure of gas

Vₐ=Volume of gas adsorbed at pressure P

Vₘ=Volume of gas adsorbed at monolayer coverage

C=BET constant

A plot of P/[Vₐ(Pₒ−P)] vs. P/Pₒ should yield a straight line with intercept 1/VₘC and slope (C−1)/VₘC. The value of Vₘ is obtained from a regression line plot though the data (typically between P/Pₒ values of 0.05 to 0.3).

The specific surface area (s) of the adsorbent is then calculated from Vₘ by:

$$s = \frac{Vm σ Na}{mVo}$$

Where:
σ=Cross-sectional area of adsorbate.
Na=Avagadro constant
Vo=Molar volume of gas

BJH method is a procedure for calculating pore size distributions using the Kelvin equation and involves conceptual emptying of condensed adsorptive (Nitrogen) from the pores in a stepwise manner as the relative pressure is likewise decreased. The pores are considered filled at the arbitrary point of about 99.5% relative pressure (P/P₀=0.995) and the pore size is calculated as per the reference

The materials prepared in Examples 1 and 2 were subjected to BET and BJH measurements described above. The results are shown below in Table 1:

TABLE 1

| | | BP2000/Iron | |
|---|---|---|---|
| | Iron Oxide* | Oxide composite | BP2000 |
| BET Surface Area | 265.2 | 1200 | 1511 |
| (m²/g) | 299.1 | | |
| | 336.1 | | |
| BJH (pore area 2-50 nm) | 125.6 | 951 | 1150 |
| (m²/g) | 219.8 | | |
| | 237.0 | | |
| BJH (pore volume) | 0.0892 | 0.480 | 0.528 |
| (cc/g) | 0.180 | | |
| | 0.174 | | |

BP2000 is a conducting activated carbon (Black Pearls).
BET surface area is total surface area including micropores (pores <2 nm).
BJH (pore area) is the surface area of mesopores (2-50 nm diameter) only.
BJH (pore volume) is the total volume of the mesopores (2-50 nm diameter).
*These results correspond to three different preparations following the methodology of Example 1.

### EXAMPLE 4

### Removal of Natural Organic Matter (Humic Substances) from Water by Mesoporous Materials

A solution of Armadale fulvic acid (Contech, Canada) was prepared from a concentrated aqueous solution by dilution in the ratio 1:50 of milli-Q water and resulted in a yellow/brown solution.

Equal portions of the dilute solution were measured into a series of four vials labelled 1 to 4. Vial number 1 was designated the blank and received no further additives. Using a spatula, approximately equal measures of BP2000 carbon, mesoporous iron (as prepared in Example 1) and carbon/iron oxide composite (as prepared in Example 2) were individually added to vials 2, 3 and 4 respectively. The vials were left overnight to equilibrate.

Observations following day:

Vial 1—Blank, no additive—yellowish brown solution, no change
Vial 2—BP2000 carbon—large reduction in colour, still slight tinge of brown. Carbon was also found to float and attach to the walls of the tube, a feature which is undesirable from a separation perspective.
Vial 3—mesoporous iron oxide—large reduction in colour although not as good as vial 2.
Vial 4—carbon/iron oxide composite—complete removal of all colour, better performance than either vial 2 or vial 3. In addition, this material settled well in the bottom of the vial, suggesting improved properties with respect to separation, when compared with vial 2.

This experiment was also performed with a 1:10 dilution resulting in a higher concentration of NOM. The observations follow a similar pattern to above.

Observations:

Vial 1—Blank, no additive—dark brown solution, no change
Vial 2—BP2000 carbon—large reduction in colour (>80%), still slight tinge of brown. Again, carbon attached to upper walls of vial and floating
Vial 3—mesoporous iron oxide—some reduction in colour, again not as significant as in vial 2.
Vial 4—carbon/iron oxide composite—Extremely good colour removal with only a slight tinge of brown left and much better performance than either vial 2 or vial 3. Again, this material separates well from the solution.

The removal of colour by these additives shows the ability of the adsorbents to remove natural organic material (NOM) (a contaminant often found in waterways), from water. This simple experiment shows the improved ability of the carbon/iron oxide composite to adsorb natural organic species over either the carbon or the iron oxide alone. Other advantages of the composite over BP2000 are the improved surface chemical properties as evidenced by the significantly greater amount of BP2000 stuck to the upper part of the vials in both series of experiments compared to the much lesser amounts for the carbon/iron oxide composite.

### EXAMPLE 5

### Preparation of Mesoporous Titanium Dioxide

12 ml of TiCl₃ solution (15% w/v as supplied) was mixed with 60 ml of Milli-Q water in a 100 ml beaker. The pH of the resultant solution was increased rapidly from approximately 8.5 using 6 M NaOH with rigorous stirring during which a blue precipitate formed. The material was left for 72 hours during which time the upper portion of the precipitate was oxidised to white titanium dioxide precipitate. The beaker was then placed in a hot oven uncovered at 105° C. overnight (14 hours). During this state the insoluble remaining blue precipitate oxidised and dehydrated to form titanium dioxide. The following morning the beaker was removed from the oven and the dry salty disk of white material that had formed was rinsed immediately with Milli-Q water. Rinsing was performed by filling the beaker with agitation, settling the solid material briefly and pouring off the supernatant. This involved the loss of a small portion of fines which were still suspended. The rinsing process was repeated 9 times. The material was then place in a vacuum oven at 70° C. and vacuum (625 mm Hg) and dried, prior to BET measurement.
TiO₂ confirmed total surface area of 250 m²/g, total pore volume 0.22 cm³/g, BJH pore volume 0.18 cm³/g, average pore radius 17.6 nm.

### EXAMPLE 6

### Preparation of Titanium Dioxide/Activated Carbon Material

12 ml of TiCl₃ (15% w/v) solution was mixed in 60 ml Milli-Q water in a 100 ml beaker. 5 g of BP2000 carbon was dispersed in this solution with gentle stirring. The pH of the resultant solution was increased rapidly to 8.6 using 6 M NaOH with rigorous stirring (magnetic bead on magnetic stirrer). The solution was equilibrated at this pH for minimum of 10 minutes. The beaker was placed in the preheated oven at 105° C. and left for two nights leaving a dried black disk in the beaker. The dried black disk was rinsed/washed with Milli-Q water. Rinsing/washing was performed by filling the beaker with water, followed by agitation, settling the solid material briefly and pouring off the supernatant. This process resulted in the loss of a small amount of fines. The rinsing process was repeated 9 times. The material was then place in a vacuum oven at 70° C. and vacuum (625 mm Hg) and dried, prior to BET measurement.

Notes.

12 ml of TiCl₃ (15% w/v) forms approximately 1 gram of TiO₂, therefore the ratio of titanium dioxide to carbon for this material is approximately 1:5.
C/TiO₂—surface area 1100 m²/g, total pore volume 1.76 cm³/g, BJH pore volume 1.59 cm³/g

### EXAMPLE 7

### Preparation of Manganese Dioxide/Activated Carbon Material

2.3 g of MnCl₂4H₂O was mixed in 60 ml Milli-Q water in a 100 ml beaker. 4 g of BP2000 carbon was dispersed in this solution with gentle stirring. The pH of the resultant solution was rapidly increased from approximately 6 to 10.5 using 6 M NaOH with rigorous stirring (magnetic bead on magnetic stirrer). The solution was equilibrated at this pH for minimum of 10 minutes. The beaker was placed in the preheated oven at 105° C. and left overnight leaving a dried black disk in the beaker. The dried black disk was rinsed/washed with Milli-Q water. The disk broke up on addition of water into suspended particles which settled on standing. Rinsing/washing was performed by filling the beaker with water, followed by agitation, settling the solid material briefly and pouring off the supernatant. This process resulted in the loss of a small amount of fines. The rinsing process was repeated 9 times. The material was then place in a vacuum oven at 70° C. and vacuum (625 mm Hg) and dried, prior to BET measurement.

Notes.

2.3 g of MnCl₂4H₂O forms approximately 1 gram of MnO₂, therefore the ratio of manganese dioxide to carbon for this material is approximately 1:4.

### EXAMPLE 8

### Preparation of Copper Oxide/Activated Carbon Material

3.14 g of CuSO₄5H₂O was mixed in 70 ml Milli-Q water in a 100 ml beaker. 1 g of BP2000 carbon was dispersed in this solution with gentle stirring. The pH of the resultant solution was rapidly increased to 11.3 using 6 M NaOH with rigorous stirring (magnetic bead on magnetic stirrer). The solution was equilibrated at this pH for minimum of 10 minutes. The beaker was placed in the preheated oven at 105° C. and left overnight leaving a dried black disk in the beaker. The dried black disk was rinsed/washed with Milli-Q water. The disk broke up on addition of water into suspended particles which settle on standing. Rinsing/washing was performed by filling the beaker with water, followed by agitation, settling the solid material briefly and pouring off the supernatant. This process resulted in the loss of a small amount of fines. The rinsing process was repeated 9 times. The material was then place in a vacuum oven at 70° C. and vacuum (625 mm Hg) and dried, prior to BET measurement.

Notes.

3.14 g of CuSO₄5H₂O forms approximately 1 gram of CuO, therefore the ratio of copper oxide to carbon for this material is approximately 1:1.

### EXAMPLE 9

### Preparation of Mesoporous Nickel Hydroxide and Nickel Oxide

2.56 g of NiCl₂6H₂O was mixed with 60 ml of Milli-Q water in a 100 ml beaker. The pH of the resultant solution was increased rapidly from approximately 12.4 using 6 M NaOH with rigorous stirring during which a pale green precipitate formed. The solution was equilibrated for 15 minutes to stabilise pH. The beaker was then placed in a hot oven uncovered at 105EC overnight (14 hours). During this state the insoluble nickel hydroxide gel network dried to form mesoporous nickel hydroxide. The following morning the beaker was removed from the oven and the dry salty disk of pale green material that had formed was rinsed immediately with Milli-Q water. Rinsing was performed by filling the beaker with agitation, settling the solid material briefly and pouring off the supernatant. This involved the loss of a small portion of fines which were still suspended. The rinsing process was repeated 9 times. The material was then place in a vacuum oven at 70° C. and vacuum (625 mm Hg) and dried, prior to BET measurement. Nickel oxide was made from the cleaned and dried nickel hydroxide formed above by further heating of the sample in a muffle furnace at 250° C.
NiOH with surface areas 164 m²/g,
NiO with surface area 207 m²/g respectively

### EXAMPLE 10

### Preparation of Nickel Hydroxide/Activated Carbon Material

2.56 g of NiCl₂6H₂O was mixed in 60 ml Milli-Q water in a 100 ml beaker. 1 g of BP2000 carbon was dispersed in this solution with gentle stirring. The pH of the resultant solution was rapidly increased to 12.1 using 6 M NaOH with rigorous stirring (magnetic bead on magnetic stirrer). The solution was equilibrated at this pH for minimum of 10 minutes. The beaker was placed in the preheated oven at 105° C. and left overnight leaving a dried black disk in the beaker. The dried black disk was rinsed/washed with Milli-Q water. The disk broke up on addition of water into suspended particles which settle on standing. Rinsing/washing was performed by filling the beaker with water, followed by agitation, settling the solid material briefly and pouring off the supernatant. This process resulted in the loss of a small amount of fines. The rinsing process was repeated 9 times. The material was then place in a vacuum oven at 70° C. and vacuum (625 mm Hg) and dried, prior to BET measurement. This produced a 50% NiOH₂ carbon composite. This method was also used, where the quantities of NiCl₂6H₂O and BP2000 carbon where changed to 3.84 g NiCl₂6H₂O and 0.5 g of BP2000 carbon and the final adjusted pH was 12.0 to produce a 75% NiOH₂ carbon composite.

Notes.

2.56 g of NiCl₂6H₂O forms approximately 1 gram of NiOH₂, therefore the ratio of nickel hydroxide to carbon for the 50% material is approximately 1:1. 3.84 g of NiCl₂6H₂O forms approximately 1.5 gram of NiOH₂, therefore the ratio of nickel hydroxide to carbon for the 75% material is approximately 3:1

The 50% NiOH₂/C had a surface area of 849 m²/g, and a BJH pore volume of 1.32 cm³/g, and an average pore diameter of 9.5 nm. The 75% NiOH₂/C has a surface area of 450 m²/g, and a BJH pore volume of 0.913 cm³/g, and an average pore diameter of 5.8 nm

### EXAMPLE 11

### Bacterial Removal from Tap Water Using Mesoporous Iron Oxide/Carbon Composite

Experimental:

(Note: Boiled sterile tap water was used in the trial.)

E. Coli (JM101) seedstock OD=0.903

Bacterial suspensions used in the adsorption experiments were prepared using: 1) tap water that was boiled to remove residual chlorine and sterilised in an autoclave prior to use and 2) E. coli culture grown in Luria Broth and washed with sterilised, boiled tap water prior to making the final suspension.

50 ml of bacterial suspension was added to 50 ml polypropylene tubes and equilibrated for 15 mins to an hour. 1 g of adsorbent was added to this suspension and incubated at room temperature on a vertically rotating platform. A control without adsorbent was also run in parallel. Samples were taken at 0, 2 and 4 hours from initial addition of adsorbent. After separating the adsorbent from the samples via settling (or brief centrifugation when required) and decanting, the adsorbent free supernatant was then subject to a number of serial dilutions with Luria Broth (neat, 1/10, 1/100, 1/1000, 1/10,000) and 100 μL of each dilution was applied to Luria agar plates.

Luria agar plates were prepared using an autoclaved, 1 litre solution of 10 g Bacto Tryptone, 5 g Yeast Extract, 10 g NaCl and 15 g Bacteriological Agar in reverse osmosis treated water. Ampicillin is added to the solution at a concentration of 100 μg/mL. 20 mL of this solution was poured into Petri dishes to form the plates in a sterile environment. The suspension is spread evenly over the agar surface using a glass spreader which is kept sterile using an ethanol/flame technique. The plates are then incubated at 37 degrees C., overnight. The colonies were counted on the plates containing between 30 and 300 colonies using a colony counter. The number of colonies from the least dilute plates were used in the calculations. The plate counts are multiplied by the dilution factor to obtain the final result.

| | | Av Log E. Coli (CFU/L) | |
|---|---|---|---|
| Sample | T = 0 Hrs | T = 2 Hrs | T = 4 Hrs |
| Control | 10.1 | 10.1 | 10.2 |
| BP2000 | 10.0 | 7.0 | 5.3 |
| Cfe (Example 2) | 10.4 | 7.5 | 6.3 |

The conclusion is that the BP2000 alone is slightly better at reducing E. Coli levels than the composite material.

### EXAMPLE 12

### Removal of Arsenic with Mesoporous Iron Oxide/Carbon Composite

Experiment: 0.5 g of mesoporous iron oxide/carbon composite was added to 50 mls of an arsenic solution. An initial arsenic concentration of 100 mg/L was used. The suspension was agitated for a minimum of approximately 19 hours. Samples of the supernatant were filtered (0.45 micron) and the arsenic concentration measured using ICP-EOS. The results of these experiments are shown in the table below.

Result:

| | Arsenic removal (%) | |
|---|---|---|
| Initial arsenic | Fe₂O₃/BP2000 composite | |
| conc. (mg/L) | (1 g/L) | BP2000 |
| 100 | 23 | 9 |

The incorporation of iron oxide into the carbon matrix more than doubled the arsenic adsorbing ability of the carbon.

### EXAMPLE 13

### pH Stability

The pH stability of the mesoporous iron oxide was found to be greater than that of the granulated oxyhydroxides such as Bayoxide E33.

Experimental:

The pH stability of mesoporous Fe₂O₃ (Example 1) was compared to Bayoxide E33 (FeOOH) available from Bayer. A quantity (0.2 grams) of each oxide was added to 50 ml of 10⁻² M KNO₃. Solutions were adjusted to pH 3 and pH 7 using HNO₃ and NaOH and place on an agitator for 1 hour. The agitator was enough to provide gentle swirling but not enough to totally suspend the material. After agitation the oxide materials were allowed to settle for approximately 15 mins, after which time a sample of supernatant was taken and acidified with a few drops of conc. nitric acid. The samples were then left overnight prior to measurement of iron concentration via ICP-EOS.

Results:

After agitation turbidity was present in both samples containing the Bayoxide E33 whereas the other two samples contained no obvious turbidity.

The iron concentrations in the acidified supernatant are indicative of the degradation of the iron oxide materials are shown in the following table:

Iron concentration in supernatant.

| pH | CSIRO Fe2O3 | Bayoxide E33 |
|---|---|---|
| 3 | 0.80 | 53 |
| 7 | 0.25 | 5.8 |

### EXAMPLE 14

Water Treatment—removal of arsenic using mesoporous iron oxide and mesoporous iron oxide/activated carbon composite (comparison basis 1 g/L each adsorbent).

Experiment: 0.5 gram of mesoporous iron oxide (Example 1) and Bayoxide E33 were separately added to 50 mls of arsenic solution. Three different initial arsenic concentrations were used. The suspensions were agitated for a minimum of approximately 19 hours. Samples of the supernatant were filtered (0.45 micron) and the arsenic concentration measured using ICP-EOS. The results of these experiments are shown in the table below.

Arsenic removal (%)

| Initial arsenic | | Bayoxide |
|---|---|---|
| conc. (mg/L) | Fe₂O₃ (1 g/L) | E33 (1 g/L) |
| 100 | 35 | 29 |
| 500 | 13 | 10 |
| 1000 | 7 | 6 |

Mesoporous iron oxide/activated carbon composite shows slightly reduced bacterial adsorption properties relative to the substrate carbon material alone, but displays enhanced arsenic adsorbing properties giving the carbon dual functionality for water treatment processes. These properties are outlined in the next two experiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Those skilled in the art will appreciate that the invention described herein is susceptible to variations and modifications other than those specifically described. It is to be understood that the invention includes all such variations and modifications. The invention also includes all of the steps, features, compositions, structures and compounds referred to or indicated in this specification, individually or collectively, and any and all combinations of any two or more of said steps or features.

### BIBLIOGRAPHY

E. P. Barrett et al. J. Amer. Chem. Soc. 73, p 373 (1951).
Brunauer, S.; Emmett, P. H.; and Teller, E., J. Am. Chem. Soc. 60, 309 (1938).
Oliviera, Luiz C. A.; Rios, Rachel V. R. A.; Fabris, Jose D.; Garg, V.; Sapag, Karam; Lago, Rochel M. Carbon 40:2177-2183, 2002.
Perez-Maqueda, Luis A.; Criado, Jose Manuel; Real, Concepcion; Balek, Vladimir; Subrt, Jan. Journal of the European Ceramic Society, 22:2277-2281 (2002).
Ross and Olivier, J. R, Physical Adsorption, J. Wiley and Sons, New York (1964).
S. J. Gregg and K. Sing; Adsorption, Surface Area and Porosity, Academic Press (1982).
S. Lowell and J. E. Shields; Powder Surface Area and Porosity, Chapman and Hall (1991)
Schwickardi, Manfred; Jaohann, Thorsten; Schmidt, Wolfgang; Schuth, Ferdi, Chem. Mater. 14:3913-3919 (2002).
Tseng, Hui-Hsin; Wey, Ming-Yen, Liang, Yu-Shen; Chen, Ke-Hao, Carbon 41:1079-1085 (2003).

1. A metal oxide/hydroxide or composite metal oxide/hydroxide material comprising a surface modified to facilitate co-continuity to an external environment, said metal oxide/hydroxide or composite material having a high mesoporous area.

2. A composite metal oxide/hydroxide material comprising a substrate with a surface modified to facilitate co-continuity to an external environment and a metal oxide/hydroxide material attached to, bound within or otherwise associated with said substrate such that the composite material maintains co-continuity to an external environment.

3. A metal oxide/hydroxide material according to claim 1 having a mesoporous area greater than 150 m²/g.

4. A composite metal oxide/hydroxide material according to claim 1 having a mesoporous area greater than 800 m²/g.

5. A process for generating a metal oxide/hydroxide material with a surface modified to facilitate co-continuity to an external environment comprising treating a metal salt with base in an aqueous medium for a time and under conditions sufficient to precipitate metal oxide/hydroxide in said aqueous medium, removing water from the aqueous medium by evaporation to provide a solid residue, and removing salt from the solid residue to thereby generate said metal oxide/hydroxide material with surface modified to facilitate co-continuity to an external environment.

6. A process for generating a metal oxide material with a surface modified to facilitate co-continuity to an external environment comprising treating a metal salt with base in an aqueous medium for a time and under conditions sufficient to precipitate metal hydroxide in said aqueous medium, removing water from the aqueous medium by evaporation under conditions that convert metal hydroxide to metal oxides to provide a solid residue, and removing salt from the solid residue to thereby generate said metal oxide material with surface modified to facilitate co-continuity to an external environment.

7. A process for generating a metal hydroxide material with a surface modified to facilitate co-continuity to an external environment comprising treating a metal salt with a base in an aqueous medium for a time and under conditions sufficient to precipitate metal hydroxide in said aqueous medium, removing water from the aqueous medium by evaporation under conditions that do not convert the metal hydroxide to metal oxide to provide a solid residue, and removing salt from the solid residue to thereby generate said metal hydroxide material with surface modified to facilitate co-continuity to an external environment.

8. A process for generating a composite metal oxide/hydroxide material with a surface modified to facilitate co-continuity to an external environment comprising treating a metal salt with a base in an aqueous medium in the presence of a substrate with a surface modified to facilitate co-continuity to an external environment for a time and under conditions sufficient to precipitate metal oxide/hydroxide, removing water from the aqueous medium by evaporation to provide a solid residue of metal oxide hydroxide attached to, bound within or otherwise associated with said substrate, and removing salt from the solid residue to thereby generate said composite metal oxide/hydroxide material with surface modified to facilitate co-continuity to an external environment.

9. A process for generating a composite metal oxide material with a surface modified to facilitate co-continuity to an external environment comprising treating a metal salt with base in an aqueous medium in the presence of a substrate with a surface modified to facilitate continuity to an external environment for a time and under conditions sufficient to precipitate metal hydroxide, removing water from the aqueous medium by evaporation under conditions that convert metal hydroxide to metal oxide to provide a solid residue of metal oxide attached to, bound within or otherwise associated with said substrate, and removing salt from the solid residue to thereby generate said composite metal oxide material with surface modified to facilitate co-continuity to an external environment.

10. A process for generating a composite metal hydroxide material with a surface modified to facilitate co-continuity to an external environment comprising treating a metal salt with base in an aqueous medium in the presence of a substrate with a surface modified to facilitate continuity to an external environment for a time and under conditions sufficient to precipitate metal hydroxide, removing water from the aqueous medium by evaporation under conditions that do not convert the metal hydroxide to metal oxide to provide a solid residue of metal hydroxide attached to, bound within or otherwise associated with said substrate, and removing salt from the solid residue to thereby generate said composite metal hydroxide material with surface modified to facilitate co-continuity to an external environment.

11. A process according to claim 5 wherein the water is removed from the aqueous medium by the application of heat.

12. A process according to claim 11 wherein the aqueous medium is heated to a temperature of from 100° C. to 110° C.

13. A process according to claim 5 wherein the salt is removed by washing the solid residue with water.

14. A process according to claim 13 wherein the washed solid residue is dried.

15. A process according to claim 5 wherein the metal oxide/hydroxide has a mesoporous area of greater than 100 m²/g.

16. A process according to claim 8 wherein the composite metal oxide/hydroxide has a mesoporous area of greater than 500 m²/g.

17. A process according to claim 5 wherein the metal salt is selected from the halides (e.g. chlorides, fluorides, bromides and iodides), acetyl acetonates, sulphides, sulphates, nitrates, nitrides, cyamides, carbides, silanes, alkoxysilanes, and acetates of transition metal elements and metal salts comprising halogen oxoanions (such as bromate and iodate), metal and transition metal oxoanions (such as permanganate, chromate and arsenate) and organic oxoanions, such alkoxides and carboxylates (e.g. ethoxides, acetates and palmitrates).

18. A process according to claim 5 wherein the metal salt is treated with an oxidizing agent to place it in a suitable oxidation state for oxide/hydroxide formation.

19. A process according to claim 5 wherein the metal salt is doped/mixed with one or more additional metals, metal salts, complexes or other chemical species to confer desirable properties on the metal oxide/hydroxide or composite metal oxide/hydroxide material.

20. A process according to claim 5 wherein the base is a strong inorganic base.

21. A process according to claim 20 wherein the base is selected from sodium hydroxide, potassium hydroxide and ammonium hydroxide.

22. A process according to claim 5 wherein the amount of base is chosen such that the final pH of the aqueous medium is in the range of 7.5 to 8.5.

23. A process for preparing a metal or composite metal material having a surface modified to facilitate co-continuity to an external environment comprising preparing a metal oxide/hydroxide or composite metal oxide/hydroxide material according to the process of claim 5 and subjecting the oxide/hydroxide or composite material to reducing conditions such that the oxide hydroxide is reduced to the corresponding metal.

24. A method for removing toxic components from an environment comprising contacting the environment with a metal oxide/hydroxide or composite metal oxide/hydroxide according to claim 1.

25. A method for catalysing a chemical reaction in a reaction medium comprising contacting the reaction medium with a metal oxide/hydroxide or composite metal oxide/hydroxide according to claim 1.

26. A method of manufacturing a supercapacitor comprising incorporating into a plate of said supercapacitors a metal oxide/hydroxide or composite metal oxide/hydroxide according to claim 1.
